(19) United States
(12) Patent Application Publication
(10) Pub. No.: US 2005/0196015 A1
(43) Pub. Date: Sep. 8, 2005

(54) Method and apparatus for tracking head candidate locations in an actuatable occupant restraining system

(75) Inventors: Yun Luo, Livonia, MI (US); Farid Khairallah, Farmington Hills, MI (US); Jon K. Wallace, Redford, MI (US)

Correspondence Address: TAROLLI, SUNDHEIM, COVELL & TUMMINO LLP, 526 SUPERIOR AVENUE, SUITE 1111, CLEVELAND, OH, 44114-1400, US

(73) Assignee: TRW Automotive U.S. LLC

(21) Appl. No.: 10/791,258

(22) Filed: Mar. 2, 2004

(51) Int. Cl. G06K 9/00; G06K 9/66; G06K 9/46

(52) U.S. Cl. 382/103; 382/190; 382/154

(57) ABSTRACT

An apparatus (100) for tracking at least one head candidate comprises an image analyzer (104) for analyzing an image signal to identify at least one of a possible plurality of new head candidates within an area of interest. The image analyzer (104) provides data regarding the identified head candidates. A tracking system (108) stores location information for at least one tracked head candidate. A candidate matcher (106) predicts the current position of a given tracked head candidate and selects a subset of the at least one of a plurality of new head candidates according to their distance from the predicted position. The similarity of each member of the selected subset to the tracked candidate is evaluated to determine if a member of the selected subset represents a current position of the tracked candidate.

### TECHNICAL FIELD

The present invention is directed to an actuatable restraining system and is particularly directed to a method and apparatus for tracking one or more occupant head candidates in an actuatable restraining system in a vehicle.

### BACKGROUND OF THE INVENTION

Actuatable occupant restraining systems having an inflatable air bag in vehicles are known in the art. Such systems that are controlled in response to whether the seat is occupied, an object on the seat is animate or inanimate, a rearward facing child seat present on the seat, and/or in response to the occupant's position, weight, size, etc., are referred to as smart restraining systems. One example of a smart actuatable restraining system is disclosed in U.S. Pat. No. 5,330,226.

Pattern recognition systems can be loosely defined as systems capable of distinguishing between classes of real world stimuli according to a plurality of distinguishing characteristics, or features, associated with the classes. A number of pattern recognition systems are known in the art, including various neural network classifiers, self-organizing maps, and Bayesian classification models. A common type of pattern recognition system is the support vector machine, described in modern form by Vladimir Vapnik [C. Cortes and V. Vapnik, “Support Vector Networks,” Machine Learning, Vol. 20, pp. 273-97, 1995].

Support vector machines are intelligent systems that generate appropriate separating functions for a plurality of output classes from a set of training data. The separating functions divide an N-dimensional feature space into portions associated with the respective output classes, where each dimension is defined by a feature used for classification. Once the separators have been established, future input to the system can be classified according to its location in feature space (e.g., its value for N features) relative to the separators. In its simplest form, a support vector machine distinguishes between two output classes, a “positive” class and a “negative” class, with the feature space segmented by the separators into regions representing the two alternatives.

### SUMMARY OF THE INVENTION

In accordance with one exemplary embodiment of the present invention, an apparatus is provided for tracking at least one head candidate. The apparatus comprises an image analyzer for analyzing an image signal to identify at least one of a plurality of possible new head candidates within an area of interest. The image analyzer provides data related to the at least one identified head candidate. A tracking system stores location information for at least one tracked head candidate. A candidate matcher predicts the current position of a given tracked head candidate and selects a subset of the identified at least one of a plurality of possible new head candidates according to their distance from the predicted position. The similarity of each member of the selected subset to the tracked candidate is evaluated to determine if a member of the selected subset represents a current position of the tracked candidate.

In accordance with another exemplary embodiment of the present invention, an air bag restraining system is provided for helping to protect an occupant of a vehicle upon the occurrence of a vehicle crash event. The apparatus comprises an air bag restraining device for, when actuated, helping to protect the vehicle occupant. A crash sensor is provided for sensing a vehicle crash event and, when a crash event occurs, provides a crash signal. An air bag controller monitors the crash sensor and controls actuation of the air bag restraining device. A stereo vision system images an interior area of the vehicle and provides an image signal of the area of interest.

An image analyzer analyzes the image signal to identify at least one of a plurality of new head candidates within an area of interest. The image analyzer provides data relating to the identified at least one head candidate. A tracking system stores location information for at least one tracked head candidate. A candidate matcher predicts the current position of a given tracked head candidate and selects a subset of the identified at least one of a plurality of possible new head candidates according to their distance from the predicted position. The similarity of each member of the selected subset to the tracked candidate is evaluated to determine if a member of the selected subset represents a current position of the tracked candidate. The candidate matcher provides a signal indicative of the current location of the at least one tracked head candidate to the air bag controller. The air bag controller controls actuation of the air bag restraining device in response to both the crash signal and the current position of the at least one tracked head candidate.

In accordance with yet another exemplary embodiment of the present invention, a head candidate matching method is provided for determining a current location of a previous head candidate. A class object is imaged to provide an image signal of an area of interest. At least one new head candidate and associated location data is determined from the image signal. The current location of the previous head candidate is predicted according to its previous location and motion. A subset of the at least one new head candidate is selected based on the distance of each of new head candidate from the predicted location. Each of the selected subset of new head candidates is compared to the previous head candidate across at least one desired feature.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of an actuatable restraining system in accordance with an exemplary embodiment of the present invention;

FIG. 2 is a schematic illustration of a stereo camera arrangement for use with the present invention for determining location of an occupant's head;

FIG. 3 is a functional block diagram of an exemplary head tracking system in accordance with an aspect of the present invention;

FIG. 4 is a flow chart showing a control process in accordance with an exemplary embodiment of the present invention;

FIG. 5 is a schematic illustration of an imaged shape example analyzed in accordance with an exemplary embodiment of the present invention;

FIG. 6 is a flow chart showing a head candidate algorithm in accordance with an exemplary embodiment of the present invention;

FIGS. 7 and 8 are schematic illustrations of imaged shape examples analyzed in accordance with an exemplary embodiment of the present invention;

FIGS. 9A-9D are flow charts depicting the head candidate algorithm in accordance with an exemplary embodiment of the present invention;

FIG. 10 is a diagram illustrating a feature extraction and selection algorithm in accordance with an exemplary embodiment of the present invention;

FIG. 11 is a flow chart depicting an exemplary head matching algorithm in accordance with an exemplary embodiment of the present invention; and

FIG. 12 is a schematic diagram depicting one iteration of the exemplary candidate matching algorithm.

### DESCRIPTION OF PREFERRED EMBODIMENT

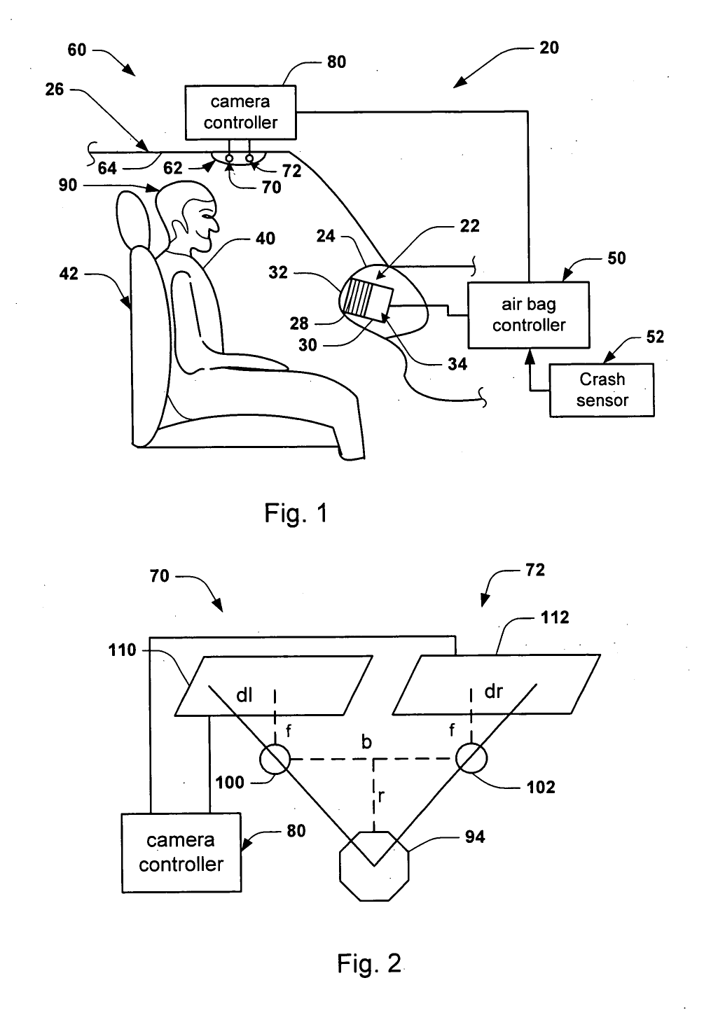

Referring to FIG. 1, an exemplary embodiment of an actuatable occupant restraint system 20, in accordance with the present invention, includes an air bag assembly 22 mounted in an opening of a dashboard or instrument panel 24 of a vehicle 26. The air bag assembly 22 includes an air bag 28 folded and stored within the interior of an air bag housing 30. A cover 32 covers the stored air bag and is adapted to open easily upon inflation of the air bag 28.

The air bag assembly 22 further includes a gas control portion 34 that is operatively coupled to the air bag 28. The gas control portion 34 may include a plurality of gas sources (not shown) and vent valves (not shown) for, when individually controlled, controlling the air bag inflation, e.g., timing, gas flow, bag profile as a function of time, gas pressure, etc. Once inflated, the air bag 28 may help protect an occupant 40, such as the vehicle passenger, sitting on a vehicle seat 42. Although the invention is described with regard to a vehicle passenger, it is applicable to a vehicle driver and back-seat passengers and their associated actuatable restraining systems. The present invention is also applicable to the control of side actuatable restraining devices.

An air bag controller 50 is operatively connected to the air bag assembly 22 to control the gas control portion 34 and, in turn, inflation of the air bag 28. The air bag controller 50 can take any of several forms such as a microcomputer, discrete circuitry, an application-specific-integrated-circuit (“ASIC”), etc. The controller 50 is further connected to a vehicle crash sensor 52, such as one or more vehicle crash accelerometers or other deployment event sensors. The controller monitors the output signal(s) from the crash sensor 52 and, in accordance with an air bag control algorithm using a crash analysis algorithm, determines if a deployment crash event is occurring, i.e., one for which it may be desirable to deploy the air bag 28. There are several known deployment crash analysis algorithms responsive to crash acceleration signal(s) that may be used as part of the present invention. Once the controller 50 determines that a deployment vehicle crash event is occurring using a selected crash analysis algorithm, and if certain other occupant characteristic conditions are satisfied, the controller 50 controls inflation of the air bag 28 using the gas control portion 34, e.g., timing, gas flow rate, gas pressure, bag profile as a function of time, etc. The present invention is also applicable to actuatable restraining systems responsive to side crash, rear crash, and/or roll-over events.

The air bag restraining system 20, in accordance with the present invention, further includes a stereo-vision assembly 60. The stereo-vision assembly 60 includes stereo-cameras 62 preferably mounted to the headliner 64 of the vehicle 26. The stereo-vision assembly 60 includes a first camera 70 and a second camera 72, both connected to a camera controller 80. In accordance with one exemplary embodiment of the present invention, the cameras 70, 72 are spaced apart by approximately 35 millimeters (“mm”), although other spacing can be used. The cameras 70, 72 are positioned in parallel with the front-to-rear axis of the vehicle, although other orientations are possible.

The camera controller 80 can take any of several forms such as a microcomputer, discrete circuitry, ASIC, etc. The camera controller 80 is connected to the air bag controller 50 and provides a signal to the air bag controller 50 to indicate the location of the occupant's head 90 relative to the cover 32 of the air bag assembly 22. The controller 50 controls the air bag inflation in response to the location determination, such as the timing of the inflation and the amount of gas used during inflation.

Referring to FIG. 2, the cameras 70, 72 may be of any several known types. In accordance with one exemplary embodiment, the cameras 70, 72 are charge-coupled devices (“CCD”) or complementary metal-oxide semiconductor (“CMOS”) devices. One way of determining the distance or range between the cameras and an object 94 is by using triangulation. Since the cameras are at different viewpoints, each camera sees the object at different position. The image difference is referred to as “disparity.” To get a proper disparity determination, it is desirable for the cameras to be positioned and set up so that the object to be monitored is within the horopter of the cameras.

The object 94 is viewed by the two cameras 70, 72. Since the cameras 70, 72 view the object 94 from different viewpoints, two different images are formed on the associated pixel arrays 110, 112, of cameras 70, 72 respectively. The distance between the viewpoints or camera lenses 100, 102 is designated “b.” The focal length of the lenses 100 and 102 of the cameras 70 and 72 respectively, is designated as “f.” The horizontal distance from the image center on the CCD or CMOS pixel array 110 and the image of the object on the pixel array 110 of camera 70 is designated “dl” (for the left image distance). The horizontal distance from the image center on the CCD or CMOS pixel array 112 and the image of the object 94 on the pixel array 112 for the camera 72 is designated “dr” (for the right image distance). Preferably, the cameras 70, 72 are mounted so that they are in the same image plane. The difference between dl and dr is referred to as the “image disparity,” and is directly related to the range distance “r” to the object 94 where r is measured normal to the image plane. It will be appreciated that
r=bf/d, where d=dl−dr. (equation 1)
From equation 1, the range as a function of disparity for the stereo image of an object 94 can be determined. It should be appreciated that the range is an inverse function of disparity. Range resolution is a function of the range itself. At closer ranges, the resolution is much better than for farther ranges. Range resolution Ar can be expressed as:
Δr=(r²/bf)Δd (equation 2)
The range resolution, Δr, is the smallest change in range that is discernible by the stereo geometry, given a change in disparity of Δd.

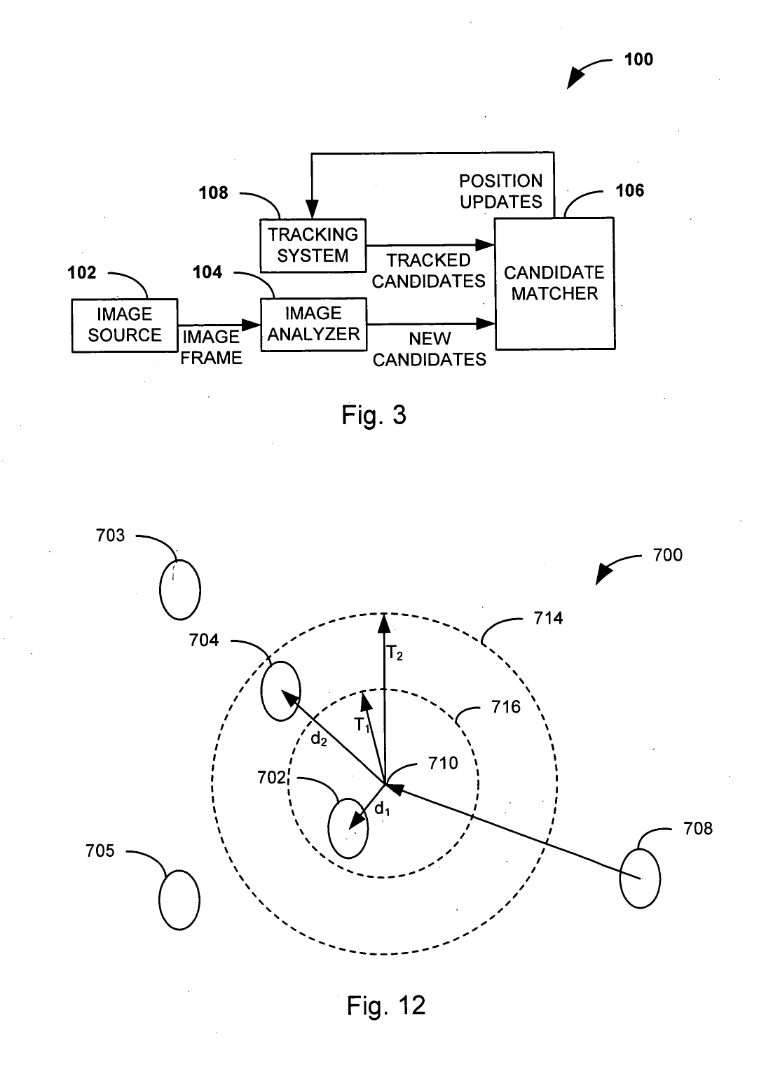

FIG. 3 illustrates an exemplary head tracking system 100 in accordance with an aspect of the present invention. It will be appreciated that the head tracking system 100 can be implemented, at least in part, as computer software operating on one or more general purpose microprocessors and microcomputers. An image source 102 images an area of interest, such as a vehicle interior, to produce an image signal. In an exemplary embodiment, the image source can include a stereo camera that images the area from multiple perspectives and combines the acquired data to produce an image signal containing three-dimensional data in the form of a stereo disparity map.

The image signal is then passed to an image analyzer 104. The image analyzer 104 reviews the image signal according to one or more head location algorithms to identify one or more new head candidates and determine associated characteristics of the new head candidates. For example, the image analyzer can determine associated locations for the one or more candidates as well as information relating to the shape, motion, and appearance of the new candidates. Each identified candidate is then classified at a pattern recognition classifier to determine an associated degree of resemblance to a human head, and assigned a head identification confidence based upon this classification.

The identified new head candidates and their associated characteristic information are provided to an image matcher 106. A plurality of currently tracked head candidates from previous image signals are also provided to the candidate matcher 106 from a tracking system 108. The tracking system 108 stores a plurality of previously identified candidates, associated tracking confidence values for the candidates, and determined characteristic data determined previously for the candidates at the image analyzer 104, such as shape, appearance, and motion data associated with the candidates. This information can include one or more position updates provided to the tracking system 108 from the candidate matcher 106.

The candidate matcher 106 matches the tracked head candidates to the new head candidates according to their relative position and their associated features. The candidate matcher 106 first predicts the location of a selected tracked head candidate according to its known position and motion characteristics. A tracked candidate provided from the tracking system 108 is then selected, and the distance between the predicted position of the tracked candidate and each new candidate is determined. For example, the distance can represent the Euclidean or city block distance between determined centers of mass of the selected tracked candidate and the new candidates.

A subset of new candidates is selected according to their distance from the predicted position. For example, a determined number of new candidates having the smallest distances can be selected, every new candidate having a distance underneath a threshold value can be selected, or a combination of the two methods can be used. In an exemplary embodiment, a predetermined number of new candidates are identified for a given tracked candidate. One or more threshold distances are defined around the predicted position of the tracked candidate, and the smallest threshold value distance that encompasses one of the identified candidates is chosen. All candidates within the selected threshold are selected for further analysis.

Each of the selected subset of new candidates is compared with the tracked candidate to determine if they resemble the tracked candidate across one or more features. For example, selected features of the tracked candidate and each of the selected subset of new candidates can be provided to a pattern recognition classifier for analysis. The classifier outputs a matching score for each of the new candidates reflecting a degree of similarity between the new candidate and the tracked candidate.

The best matching score is compared to a threshold value. If the best matching score meets the threshold value, the new head candidate associated with the best matching score is determined to match the tracked head candidate. In other words, it is determined that the new head candidate represents the new location of the tracked head candidate in the present image signal. A tracking confidence associated with the tracked head confidence is increased, and the updated location information (e.g., the location of the new head candidate) for the tracked candidate is provided to the tracking system 108.

If the best matching score does not meet the threshold value, the candidate matcher 106 determines that the selected tracked candidate does not have a corresponding new candidate in the received image signal. The system has essentially “lost track” of the selected tracked candidate. Accordingly, the tracking confidence associated with the selected head candidate can be reduced, and no update is provided to the tracking system 108. This process can be repeated for each of the tracked candidates from the tracking system 108 until all of the tracked candidates have been evaluated.

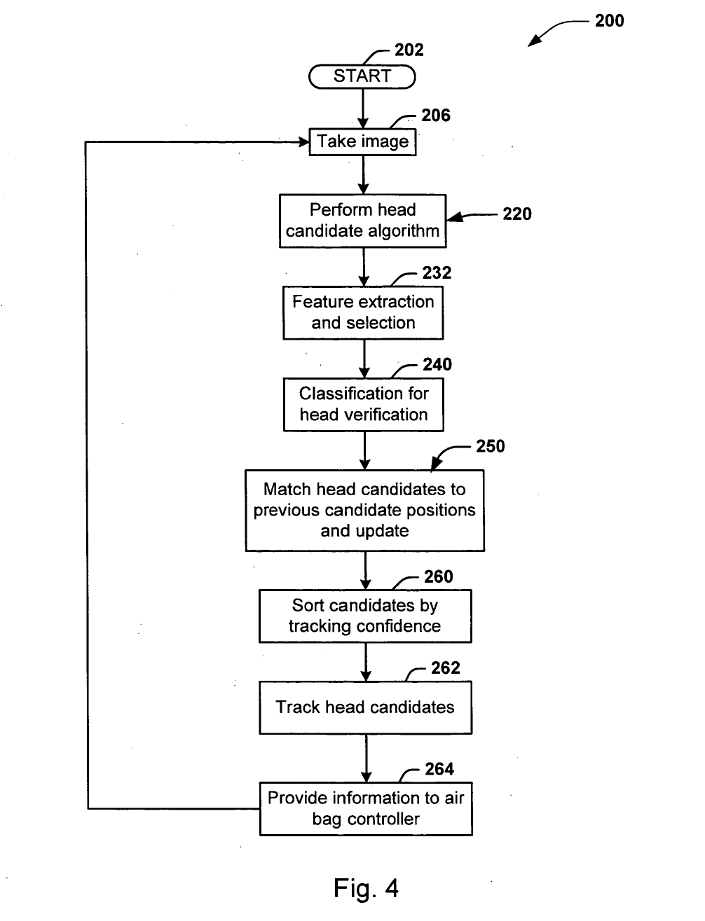

Referring to FIG. 4, a control process 200, in accordance with one exemplary embodiment of the present invention, is shown. The illustrated process determines a plurality of new head candidates and compares them to previous candidate locations (e.g., from a previous image signal) to continuously track a number of head-like shapes within a vehicle interior. The process is initialized in step 202 in which internal memories are cleared, initial flag conditions are set, etc. This initialization can occur each time the vehicle ignition is started. In step 206, a new image of the passenger seat location is taken from an imaging system within the vehicle interior. In an exemplary implementation, the image source is a stereo camera as described in FIG. 2. As mentioned, the present invention is not only applicable to the passenger seat location, but is equally applicable to any seat location within the vehicle.

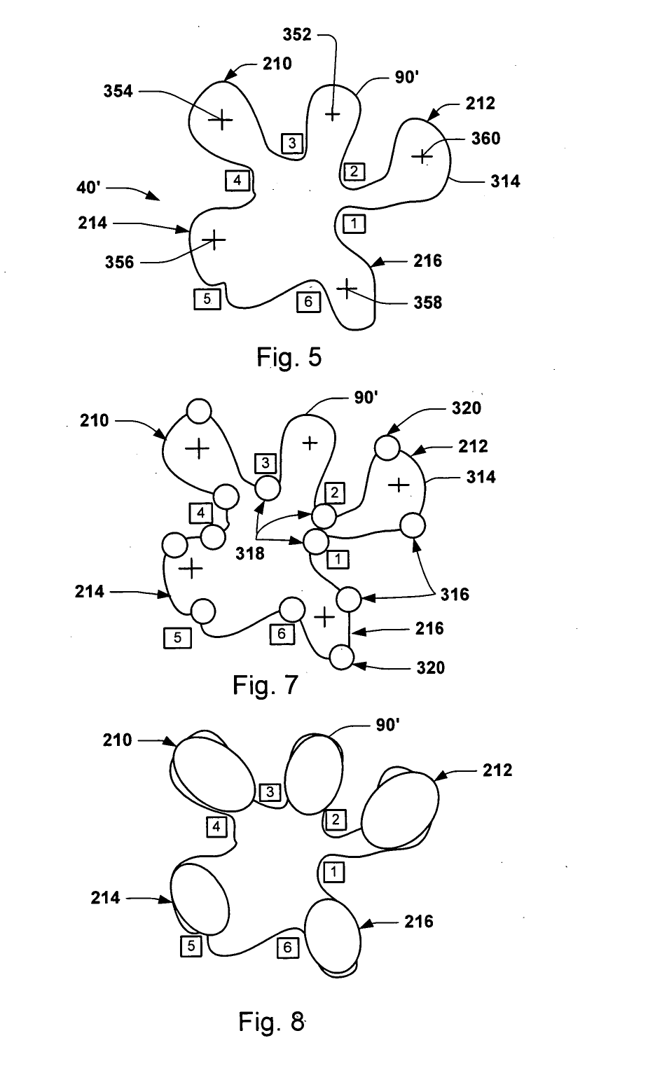

For the purposes of explanation, consider an example in which an occupant 40′ depicted in FIG. 5 having a head 90′. In this example, the occupant is holding, in his right hand a manikin's head 210, and in his left hand, a soccer ball 212. The occupant's right knee 214 and his left knee 216 are also seen in FIG. 5. Each of the elements 90′, 210, 212, 214, and 216 in this image by the cameras represent a possible head candidate. The control process determines a plurality of head candidates for each received image signal, matches the candidates between signals, tracks the candidate locations accordingly, and controls the actuatable restraining system 22 in response thereto. The tracked candidate locations are control inputs for the actuatable restraining system.

Referring back to FIG. 4, the control process 200 performs a head candidate algorithm 220. The purpose of the head candidate algorithm 220 is to establish the location of all possible head candidates within the new image signal. In FIG. 5, the head candidate location algorithm will find and locate not only head 90′ but also the manikin's head 210, the soccer ball 212, and knees 214, 216 as possible head candidate locations.

From step 220, the process proceeds to step 232 where a feature extraction and selection algorithm is performed. The feature extraction and selection algorithm 232 includes an incremental learning feature in which the algorithm continuously learns features of a head such as shape, grid features based on gray and disparity images, relative head location, visual feature extraction, and movement of the head candidate. The algorithm then determines an optimal combination of features to best discriminate heads from other objects.

In step 240, a pattern recognition classifier is used to establish a head identification confidence that indicates the likelihood that a new head candidate is a human head. For example, the classifier can be implemented as an artificial neural network or a support vector machine (“SVM”). The classifier can utilize any reasonable combination of features that discriminate effectively between human heads and non-head objects. In an exemplary embodiment, approximately 200 features can be used to identify a head. These features can include disparity features to determine depth and size information, gray scale features including visual appearance and texture, motion features including movement cues, and shape features that include contour and pose information. A confidence value is determined for each new head candidate equal to a value between 0% and 100%.

In step 250, the identified new head candidate locations are matched to tracked head candidate locations from previous signals, if any. The process compares the position of each new tracked head candidate to a location of one or more head candidates from the previous image signal. The human head movement during a vehicle pre-braking condition is limited to speeds of less than 3.1 m/s without any external forces that could launch the head/torso at faster rates. In general, the expected amount of head movement will be significantly less than this. Accordingly, the matching of the tracked candidates with the new candidates can be facilitated by determining if each new candidate is located within one or more defined threshold distances of a predicted location of a tracked head candidate. The predicted locations and associated thresholds can be determined according to known motion and position characteristics of the tracked head candidates. Prospective matches can be verified via similarity matching at a pattern recognition classifier.

It will be appreciated that not all tracked candidates will necessarily have a matching new candidate nor will every new head candidate necessarily have a corresponding tracked candidate. For example, some objects previously identified as head candidates may undergo changes in orientation or motion between image signals that remove them from consideration as head candidates or objects classified as candidates may leave the imaged area (e.g., a soccer ball can be placed in the backseat of the vehicle). Similarly, some objects previously ignored as head candidates may undergo changes that cause them to register as potential candidates and new objects can enter the imaged area.

The position of each tracked candidate is updated according to the position of its matching new head candidate. An associated tracking confidence associated with each match can also be updated at this step based on one or more of the confidence of the similarity matching, the head identification confidence of the new hypothesis, and the distance between the tracked candidate and the new candidate. The tracking confidence associated with unmatched tracked candidates can be reduced, as the system has lost the tracking of those candidates for at least the current signal. The specific amounts by which each confidence value is adjusted will vary with the interval between image signals and the requirements of a specific application.

At step 260, the matched candidates are ranked according to their associated tracking confidences. Each of the ranked candidates can be retained for matching and tracking in the next image signal, and the highest ranked candidate is provisionally selected as the occupant's head until new data is received. Any new head candidates that were not matched with tracked head candidates can also be retained, up to a maximum number of candidates. If the maximum number of candidates is reached, an unmatched candidate from the present signal having the largest head identification confidence value is selected and the confidence value is compared to a threshold. If the confidence exceeds the threshold, the lowest ranked tracking confidence is replaced by the selected unmatched candidate. The new candidate can be assigned a default confidence value or a value based on its head identification confidence.

Once a candidate has been selected as the head, the process 200 continues to step 262, where the stereo camera distance measurement and the prior tracking information for the candidates is used in a head tracking algorithm to calculate their location and movement relative to the camera center axis. The head tracking algorithm calculates the trajectory of the candidates including the selected human head. The algorithm also calculates the velocity and acceleration of each candidate. The algorithm determines respective movement profiles for the candidates and compares it to predetermined human occupant profiles and infers a probability number of the presence of absence of a human occupant in the passenger seat 42 of a vehicle 26. This information is provided to the air bag controller at step 264. The process then loops back to step 206 where new image signals are continuously acquired. The process then repeats with a newly acquired image signal.

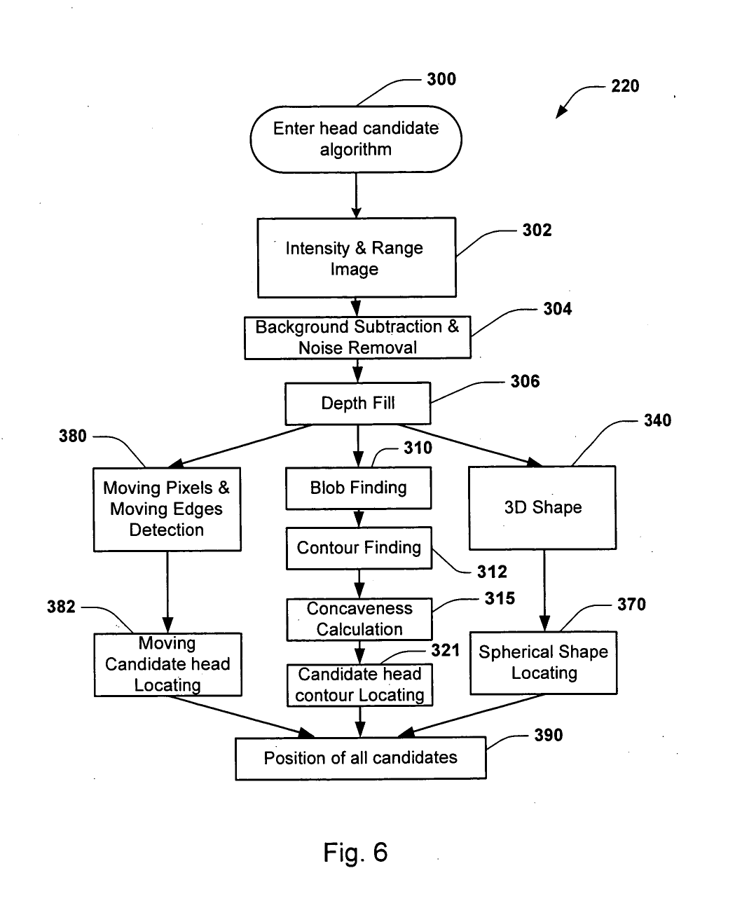

Referring to FIG. 6, the head candidate algorithm 220 will be appreciated. Although serial and parallel processing is shown, the flow chart is given for explanation purposes only and the order of the steps and the type of processing can vary from that shown. The head candidate algorithm is entered in step 300. To determine if a potential head exists, the stereo camera 62 takes a range image and the intensity and the range of any object viewed is determined in step 302. The Otsu algorithm [Nobuyuki Otsu, “A Threshold Selection Method from Gray-Level Histograms,” IEEE Transactions on Systems, Man, and Cybernetics, Vol. 9, No. 1, pp. 62-66, 1979] is used to obtain a binary image of an object with the assumption that a person of interest is close to the camera system. Large connected components in the binary image are extracted as a possible human body.

Images are processed in pairs and the disparity map is calculated to derive 3D information about the image. Background information and noise are removed in step 304. In step 306, the image signal that appears from processing of the image pairs from the stereo camera is depth filled so as to remove discontinuities of the image. Such discontinuations could be the result of black hair or non-reflective material worn by the occupant.

In step 310, a blob finding process is performed to determine a blob image such as that shown in FIG. 5. In the blob finding process, all pixels that have an intensity value equal to or greater than a predetermined value are considered to be ON-pixels and those having an intensity value less than the predetermined value are considered to be OFF-pixels. A run/length coding is used to group all the ON-pixels together to establish one or more blobs within the viewing area. Then, the largest blob area is selected for further processing by the contour based candidate generation process.

In FIG. 5, the blob image depicts an example of the contour finding algorithm 312. Specifically, a blob image is taken by the stereo cameras 62 and the background subtracted. A contour line 314 is the result of this processing.

Referring to FIGS. 6 and 7, turning point locations are identified on the body contour defined by line 314. The turning point locations are determined by finding concaveness of the shape of the body contour line 314 in the process step 315 (FIG. 6). There is a likelihood of a head candidate being located between adjacent locations of concaveness along the body contour 314. A plurality of circle areas 316, each having a predetermined diameter and each having its associated center on the contour line 314, are evaluated to determine the concaveness of the contour shape. If a particular circle area being evaluated includes more ON-pixels than OFF-pixels, then that location on the contour line 314 is considered to be concave. Assume, for example, that the radius of each circle area being evaluated is r. The center of the circle at every contour point (x, y) and the concaveness around that area of pixel (x, y) is calculated as follows:

$$Concaveness ( x , y ) = {\sum }_{i , j , ( {i}^{2} + {j}^{2} ) \leq {r}^{2}} I ( x + i , y + j ) ) / π {r}^{2}$$

where I(x, y) is a binary image with ON-pixels equal to 1 and background or OFF-pixels equal to 0.

The points with large concaveness values represent possible turning points on a body contour line 314. In FIG. 7, evaluation of circles 318 each yield a result that their associated locations are concave. Evaluation of circles 320 each yield a result that their associated locations are convex. After the evaluation of the entire contour shape 314, six areas of concaveness (identified in the square boxes labeled 1-6) are classified as turning points in this example and possible head candidate locations.

A head candidate locating process is performed in step 321 (FIG. 6). Referring to FIG. 8, for each pair of consecutive turning points 1-6, an ellipse fitting process is performed. If a contour segment connected by two consecutive turning points has a high fitting to an ellipse, it is considered a head candidate. As can be seen in FIG. 8, each of the locations 90′, 210, 212, 214, and 216 have good ellipse fits and, therefore, each are considered possible head candidate locations. There are several advantages of using ellipse to fit the head: (1) the shape of human head is more like an ellipse than other shapes and (2) the ellipse shape can be easily represented by parameters including the center coordinates (x,y), the major/minor axis (a, b) and orientation (θ). The position (center) of the ellipse is more robust to contour. From these parameters of the ellipse, the size of the ellipse (which represents the size of the head), and the orientation of the ellipse (which is defined as the orientation of the head) can be determined.

To calculate ellipse features, the second order central moments method is used. These can be represented mathematically as follows:

$$θ = \frac{1}{2} {tan}^{- 1} ( \frac{2 {μ}_{1 , 1}}{{μ}_{0 , 2} - {μ}_{2 , 0}} ) , \qquad a = \sqrt[4]{\frac{4 \sqrt{{μ}_{2 , 0}^{3}}}{π \sqrt{{μ}_{0 , 2}}}} , \qquad b = \sqrt[4]{\frac{4 \sqrt{{μ}_{0 , 2}^{3}}}{π \sqrt{{μ}_{2 , 0}}}} .$$

Based on these parameters, the following ellipse features can be calculated:
1) Length of major axis: a
2) Length of minor axis: b
3) Orientation of the major axis of the ellipse: e
4) Ratio of Minor axis by Major axis: r
5) Length of head contour: perimeter
6) Size of the head: area
7)

$$Arperat = \frac{\sqrt{area}}{perimeter}$$

The human head from infant to full adult varies by 25% in volume or perimeter. The human head size varies between a minimum and a maximum value. A head size that is outside the typical human profile is rejected as a candidate human head.

Referring back to FIG. 6, a 3D shape is determined in step 340 using a hill climbing algorithm to find all areas that have a local maximum. For a pixel (x, y) in a range image, its depth value (i.e., distance from cameras) is compared with its neighbor pixels. If its neighbor pixels have higher intensity values, which means they are closer to the cameras, the process then moves to that pixel location that has the highest intensity which is closest to the cameras. This process continues until a pixel value is found that has the disparity value larger than any of its neighbors. The neighborhood is an area of pixels being monitored or evaluated. In FIG. 5, locations 352, 354, 356, 358, and 360 marked by crosses have a local maxima found by the hill climbing algorithm and are identified at spherical shapes locations in step 370. As can be seen in FIG. 5, the manikin's head 210, the soccer ball 212, and the occupant's knees 214, 216 all have a similar spherical shapes as the true head 90′ and all are possible head candidates.

In step 380, moving pixels and moving edges are detected. To detect moving pixels, temporal edge movements are detected. The stationary objects are then distinguished from the moving occupants. 2D movement templates are combined with the 3D images to filter the shadow effects on determined movements. There is a high probability of having head/torso candidates in the moving portion of the image, i.e., a person's head will not remain stationary for a long period of time.

It is assumed that a large portion of the objects of interest are moving, whereas the background is static or stabilized. Although, in general, a motion feature alone is not enough to detect human body, it can be a very useful supporting feature to recognize the presence of a person if he or she is moving. Global and local motion analysis is used in step 382 to extract motion features.

In global motion analysis, every two adjacent image frames are subtracted to calculate the number of all moving pixels. The difference image from two consecutive frames in a video sequence removes noise such as range information drop out and disparity calculation mismatch. Therefore, the result yields a good indication of whether there is a moving object in the imaged area.

The vertical and horizontal projections of the difference image are calculated to locate concentrations of moving pixels. The concentrated moving pixels usually correspond to fast moving objects such as the moving head or hand. The process searches for peaks of movement in both the horizontal and vertical directions. The location (x, y) of the moving object is chosen that corresponds to the peaks from the horizontal movement of pixels and the peak from the vertical movement of pixels. These (x, y) locations are considered as a possible head candidate locations.

From the head candidate locations identified in steps 321, 370, and 382, the position of all candidates are identified in step 390. The process then returns and proceeds to step 232 in FIG. 4.

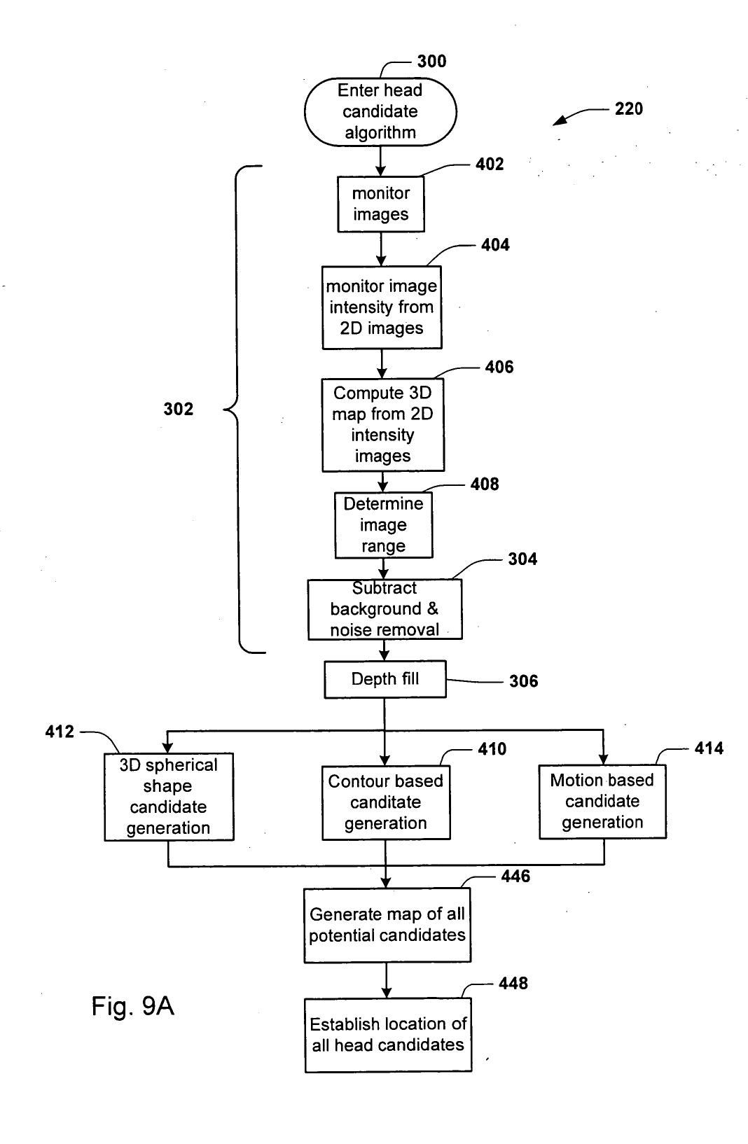

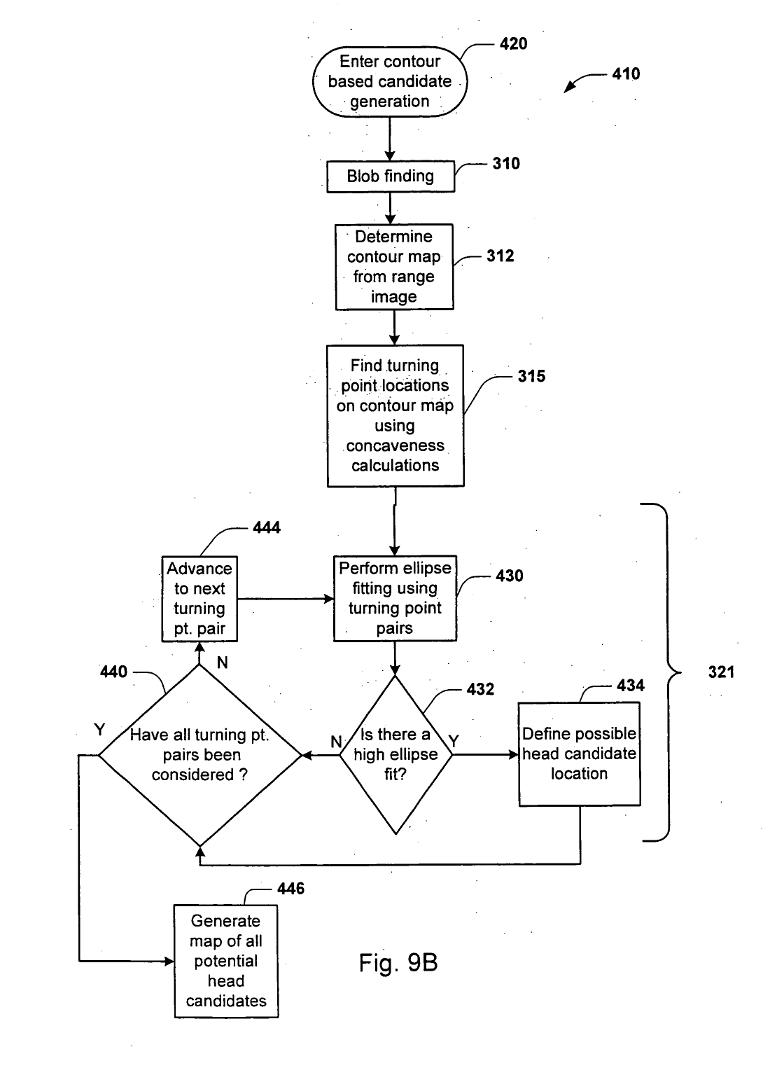

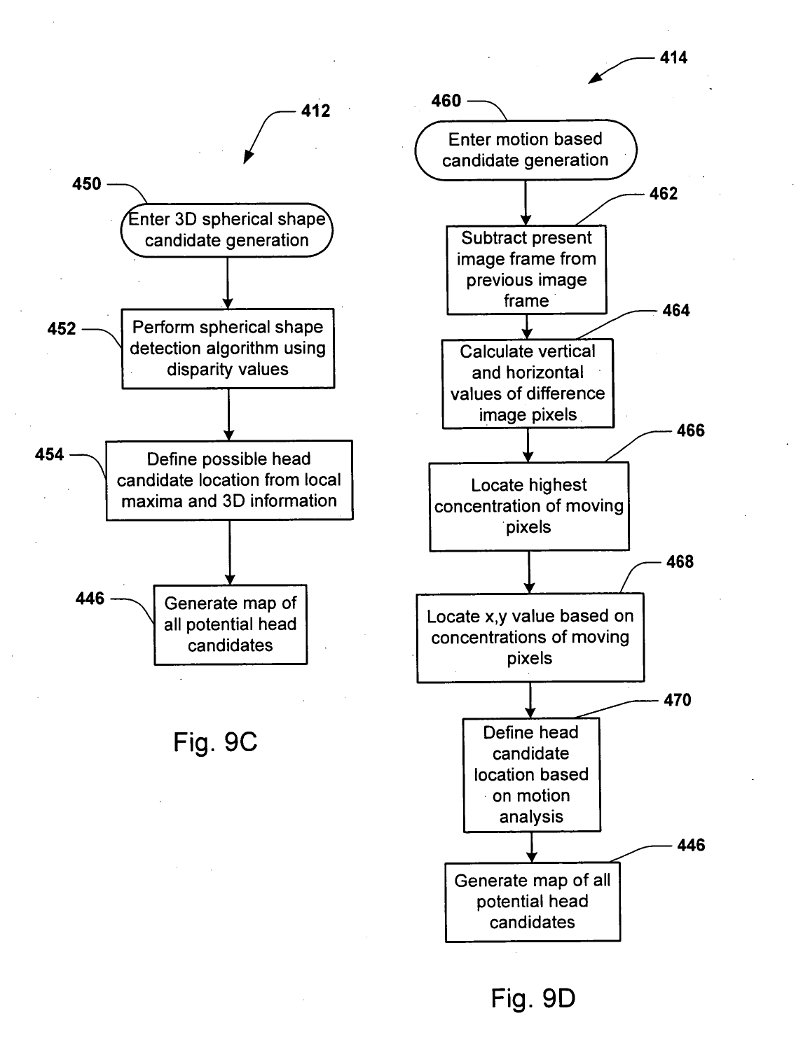

Referring to FIGS. 9A-9D, a more detailed representation of the head candidate algorithm 220 is shown. Numeric designation of the process steps may be different or the same as that shown in FIG. 6. Specifically referring to FIG. 9A, the head candidate algorithm is entered in step 300. Images are monitored in step 402 and the monitor image intensity is determined from 2D images in step 404. In step 406, a 3D representation of the image is computed from the 2D intensity image. In step 408, the image range is determined. The background is subtracted out in step 304 and the noise is removed. The depth fill process is carried out in step 306. The depth fill fills in intensity values to correct for discontinuities in the image that are clearly erroneous.

The process 220 then branches into three candidate generation processes including the contour based candidate generation 410 (corresponding to steps 310, 312, 315, and 321 in FIG. 6), the 3D spherical shape candidate generation 412 (corresponding to steps 340 and 370 in FIG. 6), and the motion based candidate generation 414 (corresponding to steps 380 and 382 in FIG. 6).

Referring to FIG. 9B, the contour based candidate generation is entered at 420. In step 310, the blob finding process is carried out. As described above, in the viewing area, all pixels that have a predetermined or greater intensity value are considered to be ON-pixels and those having an intensity value less than the predetermined value are considered to be OFF-pixels. A run/length coding is used to group all the ON-pixels together to establish one or more blobs within the viewing area. Then, the largest blob area is selected for further processing by the contour based candidate generation process 410.

In step 312, the contour map for the largest determined blob is determined from the range image. In step 315, the turning point locations on the contour map are determined using the concaveness calculations. The candidate head contour locating process 321 includes performing an ellipse fitting process carried out between adjacent turning point pairs in step 430. In step 432, a determination is made as to whether there is a high ellipse fit. If the determination in step 432 is affirmative, the process defines that location as a possible head candidate location in step 434. From step 434 or a negative determination in step 432, the process proceeds to step 440 where a determination is made as to whether all turning point pairs have been considered for ellipse fitting. If the determination in step 440 is negative, the process proceeds to step 444 where the process advances to the next turning point pair for ellipse fitting analysis and then loops back to step 430. If the determination in step 440 is affirmative, the process proceeds to step 446 where a map of all potential head candidates are generated based on the results of the processes of steps 410, 412, and 414.

Referring to FIG. 9C, the 3D spherical shape candidate generation will be better appreciated. The process is entered at step 450 and the spherical shape detection algorithm is performed using disparity values in step 452. All possible head candidate locations are defined from the local maxima and 3D information obtained from the hill climbing algorithm in step 454. The maps of all potential head candidates are generated in step 446.

Referring to FIG. 9D, the motion-based candidate generation 414 will be better appreciated. The process is entered in step 460. In step 464, the present image frame is subtracted from the previous image. The vertical and horizontal values of difference image pixels are calculated in step 464. In step 466, the highest concentration of moving pixels is located and the (x, y) values based on the concentrations of moving pixels are located in step 468. The head candidate location based on motion analysis is performed in step 470. The map of all potential head candidates is generated in step 446.

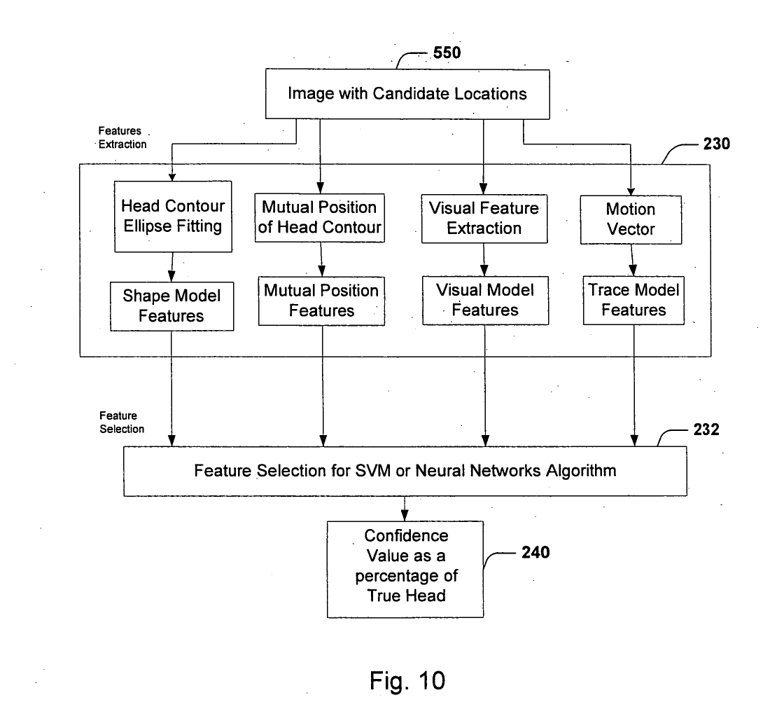

Referring to FIG. 10, the feature extraction, selection and head verification process (i.e., steps 232, and 240) will be better appreciated. The image with the candidate locations 550 after hypothesis elimination is provided to the feature extraction process of step 230. For head detection, a Support Vector Machine (“SVM”) algorithm and/or a Neural Network (“NN”) learning based algorithm are used to determine a degree of resemblance between a given new candidate and a defined prototypical human head. In order to make the SVM and/or NN system effective, it is important to find features that can best discriminate heads from other objects.

The SVM based algorithm is used with an incremental learning feature design. Support Vector Machine based algorithm, in addition to its capability to be used in a supervised learning applications, is designed to be used in an incremental learning mode. The incremental learning feature enables the algorithm to continuously learn after it is fielded to accommodate any new situations and/or new system mission profiles.

The following features, head shape descriptors, grid features of both gray and disparity images, relative head location, and head movements improve the probability of finding and tracking the head candidates. Other types of features are statistic features extracted from gray and disparity images using a grid structure. The following statistic features are extracted from each grid area:

$$\begin{matrix}\begin{matrix}1 ) & Average Intensity \text{:} \overline{I} = \frac{{\sum }_{i = 1}^{n} {I}_{i}}{n}\end{matrix} \\ \begin{matrix}2 ) & Variance of average gray scale : σ = \sqrt{\frac{{\sum }_{i = 1}^{n} {( {I}_{i} - \overline{I} )}^{2}}{n - 1}}\end{matrix} \\ \begin{matrix}3 ) & Coarseness \text{:} Co = {\sum }_{( x , y ) ∈ Region} C ( x , y )\end{matrix}\end{matrix}$$

The coarseness is used to represent the texture.

The relative head location is measured by the length and orientation of the head-body vector that connects the centroid of the body contour and the centroid of the head candidate contour. The head-body vector gives a clue of what the person's stance appears to be. The vector can measure whether a person is straight-up or is lying down. If the head-body vector indicates that the head is far below the body position, we can eliminate this as a head candidate.

Motion vector, (d, θ) or (dx, dy) of the head is used to represent the head moving patterns. Head movement usually follows certain patterns such as a smooth and continuous trajectory between consecutive frames. Therefore, the head location can be predicted based on its previous head movement. Six dimensional head trace features are extracted, M_V={xᵢ^{t}, yᵢ^{t}, dxᵢ^{t}, dyᵢ^{t}, dx^{(t-1)}, dy^{(t-1)}}, to represent the head candidate moving patterns. These trace features indicate the current and previous location of the candidate head and the information of how far the candidate head has moved. The multiple features are then provided for feature selection and classification.

Important features that can be used to discriminate determine the resemblance of a head candidate to a human head include intensity, texture, shape, location, ellipse fitting, gray scale visual features, mutual position, and motion.

The SVM algorithm or the Neural Network algorithm will output a confidence value between 0 and 1 (0% to 100%) as to how close the candidate head features compare to preprogrammed head features. In addition, the mutual position of the candidate in the whole body object is also very important. The Support Vector Machine SVM Algorithm and/or a Neural Networks NN algorithm requires training of a data base. Head images and non-head images are required to teach the SVM algorithm and/or Neural Network the features that belong to a human head and the head model.

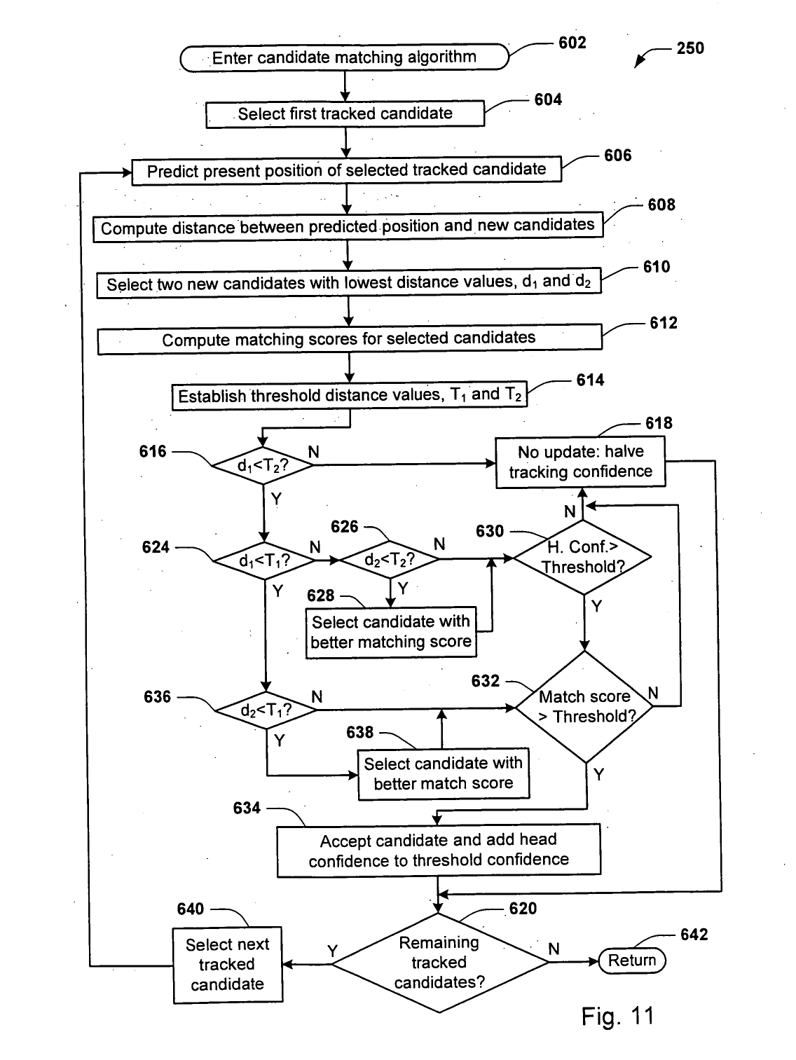

Referring to FIG. 11, an exemplary candidate matching algorithm 250 will be better appreciated. Throughout the following discussion of FIG. 11, for the sake of clarity, confidence values for various entities are discussed as increasing with increased confidence in a classification, such that a classification with a good match can exceed a given threshold. It will be appreciated, however, that the confidence values can be expressed as error or distance values (e.g., as distance measurement in feature space) that decrease with increased confidence in the classification. For confidence values of this nature, the inequality signs in the illustrated diagram and the following discussion would be effectively reversed, such that it is desirable for a confidence value to fall below a given threshold value.

The process is entered at step 602. In step 604, a first tracked candidate location is selected from a pool of at least one currently tracked head candidate. At 606, the current position of the selected candidate is predicted. The predicted position can be determined from known position and motion data of the selected candidate, obtained, for example, in a prior iteration of the head tracking algorithm. A Kalman filter or similar linear prediction algorithm can be utilized to determine a predicted location from the available data.

At step 608, a distance value is calculated for each of a plurality of new head candidates indicating their distance from the predicted location. A determined distance value can be calculated as a Euclidian distance between respective reference points, such as a center of mass of a given new candidate and a virtual center of mass associated with the determined position. Alternatively, other distance models, such as a city block distance calculation or a distance calculation based on the Thurstone-Shepard model. At step 610, one or more of the new candidates having minimum distance values are selected for analysis. In the illustrated example, two of the new candidates are selected, a first candidate having a minimum distance value, d₁, and a second candidate having a next smallest distance value, d₂. It will be appreciated, however, that other implementations of the head matching algorithm can select more or fewer than two of the new candidates for comparison.

At step 612, matching scores are calculated for the selected new candidates. The matching scores reflect the similarity between their respective new candidate and the tracked candidate. In an exemplary embodiment, the matching scores represent a confidence output from a pattern recognition classifier. Feature data, associated with one or more desired features, extracted from an identified new candidate can be input to the classifier along with corresponding feature data associated with the tracked candidate. The resulting confidence value indicates the similarity of the new candidate and the tracked candidate across the desired features. Exemplary features include visual features of the candidates, such as coarseness, contrast, and grayscale intensity, shape features associated with the candidates, such as the orientation, elliptical shape, and size of the candidates, and motion features, such as velocity and the direction of motion.

At step 614, one or more threshold distances are established relative to the predicted location of the tracked head candidate. These threshold distances can be determined dynamically based on known movement properties of the tracked candidate, or represent fixed values determined according to empirical data on head movement. In the illustrated example, two threshold distances are selected, an inner threshold T₁ representing a normal or average amount of head movement for a vehicle occupant, and an outer threshold T₂, representing a maximum amount of head movement expected for an occupant under normal circumstances. It will be appreciated, however, that other implementations of the head matching algorithm can utilize more or fewer threshold values.

At step 616, it is determined if the first new candidate has an associated distance value, d₁, less than the outer threshold distance, T₂. If the distance value associated with the first new candidate is greater than the outer threshold (N), there are no suitable new candidates for matching with the selected tracked candidate. The process advances to step 618, where a tracking confidence value associated with the selected tracked candidate is halved. The process then advances to step 620 to determine if there are tracked candidates remaining to be matched.

If the distance value associated with the first candidate is greater than the outer threshold distance (Y), the process advances to step 624. At step 624, it is determined if the first new candidate has an associated distance value, d₁, less than the inner threshold distance, T₁. If the first distance value is greater (N) than the threshold value, the process then advances to step 626, where it is determined if the second new candidate has an associated distance value, d₂, less than the outer threshold distance, T₂.

If the distance value associated with the second new candidate is less (Y) than the outer threshold, both new candidates present viable matches for the selected tracked candidate. Accordingly, the process advances to step 628, where the matching scores for each candidate, as computed at step 610, are compared and the candidate with the largest matching score is selected. The process then advances to step 630. If the distance value associated with the second new candidate is greater (N) than the outer threshold, the first candidate represents the best new candidate for matching. Accordingly, the process advances directly to step 630 to determine if the first candidate has an associated head identification confidence larger than the confidence threshold.

At step 630, a head identification confidence value associated with the selected candidate is compared to a threshold confidence value. The head identification confidence value is computed when the candidate is first identified based upon its similarity to a human head. If the head confidence value for the selected candidate is less than a threshold value (N), the process proceeds to step 618, where the tracking confidence of the tracked candidate is halved and then to step 620 to determine if there are tracked candidates remaining to be matched.

If the head identification confidence value is greater than the threshold value (Y), the process advances to step 632. At step 632, the matching score associated with the selected head candidate is compared to a threshold value. A sufficiently large score indicates a high likelihood that the two head candidates represent the same object at two different times (e.g., subsequent image signals). If the matching score does not exceed the threshold value (N), the process proceeds to step 618, where the tracking confidence of the tracked candidate is halved and then to step 620 to determine if there are tracked candidates remaining to be matched.

If the matching score exceeds the threshold value (Y), the process advances to step 634, where the selected new candidate is accepted as the new location of the selected tracked candidate. The location of the tracked head candidate is updated and the head confidence associated with the new head candidate is added to a tracking confidence associated with the tracked head candidate. The selected new head candidate can also be removed from consideration in matching other tracked candidates. The process then advances to 620 to determine if there are tracked candidates remaining to be matched.

Returning to step 624, if the distance value associated with the first candidate is less than the inner threshold distance (Y), the process advances to step 636. At step 636, it is determined if the second new candidate has an associated distance value, d₂, less than the inner threshold distance, T₁.

If the distance value associated with the second new candidate is less (Y) than the inner threshold, both new candidates present viable matches for the selected tracked candidate. Accordingly, the process advances to step 638, where the matching scores for each candidate, as computed at step 610, are compared and the candidate with the largest matching score is selected. The process then advances to step 632. If the distance value associated with the second new candidate is greater (N) than the inner threshold, the first candidate represents the best new candidate for matching. Accordingly, the process advances directly to step 632.

At step 632, the matching score associated with the selected head candidate is compared to a threshold value. If the matching score does not exceed the threshold value (N), the process proceeds to step 618, where the tracking confidence of the tracked candidate is halved and then to step 620 to determine if there are tracked candidates remaining to be matched.

If the matching score exceeds the threshold value (Y), the process advances to step 634, where the selected new candidate is accepted as the new location of the selected tracked candidate. The location of the tracked head candidate is updated and the head confidence associated with the new head candidate is added to a tracking confidence associated with the tracked head candidate. The selected new head candidate can also be removed from consideration in matching other tracked candidates. The process then advances to 620 to determine if there are tracked candidates remaining to be matched.

At step 620, it is determined if additional tracked candidates are available for matching. If so (Y), the process advances to step 640, where the next tracked candidate is selected. The process then returns to step 606 to attempt to match the selected candidate with one of the remaining new candidates. If not (N), the candidate matching algorithm terminates at 642 and the system returns to the control process 200.

FIG. 12 illustrates a schematic diagram 700 depicting one iteration of the exemplary candidate matching algorithm 600. In the illustrated example, four new head candidates identified in a current image signal 702-705 are considered for matching with a tracked candidate 708 that was identified in a past image signal. Initially, a projected location 710 is determined for the tracked candidate. This projected location can be determined according to the known characteristics of the tracked candidate 708. For example, if the tracked candidate has been tracked for several signals, a Kalman filter or other linear data filtering/prediction algorithm can be used to estimate the current position of the tracked candidate from its past locations.

Respective distance values are calculated for each of the new head candidates 702-705 reflecting the distance of each new head candidate from the projected location 710. A predetermined number of new candidates are selected as having the lowest distance values. In the present example, two candidates are selected, a first candidate 702, having a lowest distance value, d₁, and a second candidate 704, having a next lowest distance value, d₂.

One or more threshold distances 714 and 716 are then defined around the projected location 710. The threshold distances 714 and 716 can represent predefined threshold values derived via experimentation, or they can be calculated dynamically according to motion characteristics of the tracked candidate 708. In the illustrated example, two threshold distances are defined, an outer threshold distance 714 and an inner threshold distance 716.

The position of the selected new candidates 702 and 704 relative to the threshold distance can be determined to further limit the set of selected new candidates. For example, the smallest threshold distance value greater that the distance value associated with the first new candidate 702 can be determined. In the present example, the first candidate 702 is located inside of the inner threshold 716. It is then determined if the second candidate also falls within the determined threshold. If not, the first candidate 702 is selected for comparison. If so, the candidate having the greatest similarity to the tracked candidate (e.g., the highest similarity score) is selected for analysis. In the present example, the second candidate 704 is not located inside the inner threshold 716. Accordingly, the first candidate 702 is selected.

The matching score of the selected candidate is compared to a threshold value. If the threshold is met, the selected candidate is determined to be a match for the tracked candidate 708. In other words, the selected candidate is identified as the position of the tracked candidate in the present image signal. As a result, the location of the tracked candidate 708 is updated to reflect the new location, and a tracking confidence value associated with the tracked value is increased.

From the above description of the invention, those skilled in the art will perceive improvements, changes and modifications. Such improvements, changes, and modifications within the skill of the art are intended to be covered by the appended claims.

1. An apparatus for tracking at least one head candidate, said apparatus comprising:
an image analyzer for analyzing an image signal to identify at least one of a plurality of possible new head candidates within an area of interest and for providing data related to the identified at least one head candidate;
a tracking system that stores location information for at least one tracked head candidate; and
a candidate matcher that predicts the current position of a given tracked head candidate, selects a subset of the at least one of the plurality of possible new head candidates according to their distance from the predicted position, and evaluates the similarity of each member of the selected subset to the tracked candidate to determine if a new head candidate within the selected subset represents a current position of the tracked head candidate.

2. The apparatus of claim 1, further comprising an image source that provides the image signal to the image analyzer.

3. The apparatus of claim 2 wherein the image source includes a stereo camera.

4. The apparatus of claim 1 wherein the candidate matcher updates the location information at the tracking system according to the determined matches.

5. The apparatus of claim 1 wherein a confidence value associated with the given tracked candidate is updated at the tracking system according to the evaluation of the candidate matcher.

6. The apparatus of claim 1 wherein the candidate matcher selects a predetermined number of the identified at least one of a plurality of possible new head candidates that are closest to the predicted location.

7. The apparatus of claim 1 wherein the candidate matcher determines at least one threshold distance based on the projected location and selects all of the identified at least one of a plurality of possible new head candidates falling within a selected one of the determined at least one threshold distance.

8. The apparatus of claim 7 wherein a confidence value associated with the given tracked candidate is updated according to the position of the selected subset of the identified at least one of a plurality of possible head candidates relative to the at least one threshold distance and the evaluated similarity of identified at least one of a plurality of possible head candidates to the tracked candidate.

9. The apparatus of claim 1 wherein the candidate matcher matches a given tracked head candidate with one of the selected subset of the identified at least one of a plurality of possible new head candidates according to respective similarity scores associated with the subset of new head candidates, a given similarity score reflecting a degree to which an associated new head candidate resembles the tracked head candidate across at least one feature.

10. The apparatus of claim 9 wherein a given similarity score is calculated by a pattern recognition classifier.

11. The apparatus of claim 1 wherein the image analyzer includes means for performing a head candidate algorithm using the image signal to identify the at least one of the plurality of possible new head candidates in the area of interest.

12. The apparatus of claim 11 wherein the image analyzer further includes means for determining the position of the at least one of the plurality of possible new head candidates.

13. The apparatus of claim 11 wherein the means for performing the head candidate algorithm includes first determining means for determining a blob image from the image signal.

14. The apparatus of claim 13 wherein said means for performing the head candidate algorithm further includes second determining means for determining a contour of the blob image and establishing a contour image in response thereto.

15. The apparatus of claim 14 wherein said means for performing the head candidate algorithm further includes third determining means for determining turning point locations of the contour image.

16. The apparatus of claim 15 wherein said means for performing the head candidate algorithm further includes means for performing an ellipse fitting algorithm for determining the quality of ellipse fits of the contour image between determined turning point locations.

17. The apparatus of claim 11 wherein said means for performing the head candidate algorithm includes means for determining at least one of a 3D spherical shape head candidate, a contour based head candidate, and a motion based head candidate from the image signal.

18. The apparatus of claim 1 further including an air bag and means for controlling the air bag in response to the current position of the at least one tracked head candidate.

19. An air bag restraining system for helping to protect an occupant of a vehicle upon the occurrence of a vehicle crash event, said apparatus comprising:
an air bag restraining device for, when actuated, helping to protect the vehicle occupant;
crash sensor for sensing a vehicle crash event and, when a crash event occurs, providing a crash signal;
an air bag controller for monitoring the crash sensor and controlling actuation of the air bag restraining device;
a stereo vision system for imaging an interior area of the vehicle and providing an image signal of the area of interest;
an image analyzer for analyzing the image signal to identify at least one of a plurality of possible new head candidates within an area of interest and for providing data related to the identified at least one head candidate;
a tracking system that stores location information for at least one tracked head candidate: and
a candidate matcher that predicts the current position of a given tracked head candidate, selects a subset of the identified at least one of a plurality of possible new head candidates according to their distance from the predicted position, evaluates the similarity of each member of the selected subset to the tracked candidate to determine if a new head candidate within the selected subset represents a current position of the tracked head candidate, and provides a signal to the air bag controller indicating the current position of each of the at least one tracked head candidates;
the air bag controller controlling actuation of the air bag restraining device in response to both the crash signal and the current position of the at least one tracked head candidate.

20. A head candidate matching method for determining a current location of a previous head candidate, the method comprising the steps of:
imaging a class object and providing an image signal of an area of interest;
identifying at least one of a plurality of possible new head candidates and associated location data from the image signal;
predicting the current location of the previous head candidate according to its previous location and motion;
selecting a subset of the identified at least one of the plurality of possible new head candidates based on the distance of each of the identified at least one of the plurality of possible new head candidates from the predicted location; and
comparing each of the selected subset of new head candidates to the previous head candidate across at least one desired feature.

21. The method of claim 20 wherein the step of imaging a class object includes using a stereo camera.

22. The method of claim 20 wherein selecting a subset of the identified at least one of a plurality of possible new head candidates includes selecting a predetermined number of the identified at least one of a plurality of possible new head candidates that are closest to the predicted location.

23. The method of claim 20 wherein selecting a subset of the identified at least one of a plurality of possible new head candidates includes establishing a threshold distance around the predicted location and selecting every new head candidate within the threshold distances.

24. The method of claim 23 wherein selecting a subset of the identified at least one of a plurality of possible new head candidates includes establishing a plurality of threshold distances around the predicted location and selecting every new head candidate within a selected one of the plurality of threshold distances.

25. The method of claim 24, the method further comprising selecting the smallest threshold distance encompassing at least one new head candidate.

26. The method of claim 24, the method further comprising updating a tracking confidence associated with the previous head candidate according to the selected threshold distance.

27. The method of claim 24 the plurality of threshold distances comprising an inner threshold distance and an outer threshold distance and the method further comprising comparing a confidence value associated with a selected new head candidate to a threshold value only if the selected new head candidate falls between the inner threshold distance and the outer threshold distance.

28. The method of claim 20 wherein comparing the selected subset of new head candidates to the previous head candidate includes computing a similarity score for each selected new head candidate based upon its similarity to the previous head candidate and identifying the new head candidate with the best similarity score as the current location of the previous head candidate.

29. The method of claim 28 wherein computing the similarity score for a given new head candidate includes providing feature data associated with the new head candidate and feature data associated with the previous head candidate to a pattern recognition classifier.

30. A method for tracking a previously identified head candidate, comprising:
imaging a class object and providing an image signal of an area of interest;
identifying at least one of a plurality of possible new head candidates and associated location data from the image signal;
predicting the current location of the previous head candidate according to its previous location and motion;
defining at least one threshold distance around the predicted location; and
updating a tracking confidence value associated with the previously identified head candidate according to respective positions of the identified at least one of the plurality of new head candidates relative to the at least one defined threshold distance.

31. The method of claim 30 wherein updating the tracking confidence value includes decreasing the tracking confidence value when no identified new head candidate is encompassed by a selected one of the defined at least one threshold distance.

32. The method of claim 30 wherein updating the tracking confidence value includes the steps of:
selecting a defined threshold distance;
selecting a new head candidate within the selected defined threshold distance; and
adding a value reflecting the similarity of the new head candidate to a human head to the tracking confidence value.

33. The method of claim 32 wherein selecting a defined threshold distance includes selecting the smallest threshold distance encompassing at least one new head candidate.
